(19) United States
(12) Patent Application Publication
(10) Pub. No.: US 2002/0171313 A1
(43) Pub. Date: Nov. 21, 2002

(54) Slip ring and method of manufacturing slip ring

(76) Inventors: David Paul Queener, Mount Prospect, IL (US); Richard A. Mead, Granville, OH (US)

Correspondence Address: F. William McLaughlin, Wood, Phillips, VanSanten, Clark & Mortimer, 500 West Madison Street, Suite 3800, Chicago, IL, 60661-2511, US

(21) Appl. No.: 09/859,136

(22) Filed: May 16, 2001

(51) Int. Cl. H02K 1/00; H01R 39/08

(52) U.S. Cl. 310/232

(57) ABSTRACT

A slip ring for a rotary electric machine includes a cylindrical ring of electrically conductive material. The ring has a generally smooth outer surface and a patterned inner surface. A core of thermosetting material is at least partially received in the cylindrical ring. The core has a through opening receivable on a rotor of a rotary electric machine and a patterned outer surface mating with the cylindrical ring patterned inner surface to secure the cylindrical ring to the core.

### BACKGROUND OF THE INVENTION

The present invention relates to a slip ring for a rotary electric machine and, more particularly, to a slip ring having improved locking between a conductive ring and a core.

Slip rings are used on rotary electric machines, such as automotive alternators, to transfer electrical power between a rotating coil mounted on a rotor and stationary brushes. One example of a typical slip ring is shown in Rasmussen, U.S. Pat. No. 5,327,037.

Slip rings for automotive alternators are of a small size and are typically made of a copper ring or rings with a molded in core of thermosetting plastic. Most commonly, a single copper ring is used which is split into two rings at the same time the contact surface is lathed in situ. In some instances the rings are cut from a length of tubing. In other instances the rings are deep drawn into a cup and then punched out at the bottom. This operation may take as many as ten or more processing steps to produce a suitable cylindrical ring. One known slip ring design formed using such a method includes radially inwardly directed tabs at one end of the ring and circumferentially spaced skives on an inner surface at an opposite end of the ring. Still other rings are sintered from powdered metal. These designs provide minimal mechanical locking of the ring to the molded core. Also, these designs use a continuous copper ring. Differential thermal expansion between the copper rings and the molded core as well as dynamic forces require sufficient mechanical locking of the ring to the core to prevent failure.

### SUMMARY OF THE INVENTION

In accordance with the invention there is provided a slip ring for a rotary electric machine having a cylindrical ring secured to a core.

Broadly, there is disclosed herein a slip ring for a rotary electric machine including a cylindrical ring of electrically conductive material. The ring has a generally smooth outer surface and a patterned inner surface. A core of thermosetting material is at least partially received in the cylindrical ring. The core has a through opening receivable on a rotor of a rotary electric machine and a patterned outer surface mating with the cylindrical ring patterned inner surface to secure the cylindrical ring to the core.

It is a feature of the invention that the patterned inner surface comprises a plurality of circumferentially extending dovetail grooves and the patterned outer surface comprises a plurality of circumferentially extending dovetail ribs to define dovetail joints. The grooves include longitudinally spaced indentations and the ribs include nubs that extend into the indentations to prevent rotational movement between the ring and the core, and thus minimizing the stresses transferred to the terminal weld joints.

It is another feature of the invention that the cylindrical ring comprises a longitudinally extending discontinuity. In one embodiment of the invention the discontinuity comprises a straight butt joint. In other embodiments of the invention, the discontinuity may be comprised of a lockstitch joint, a diagonal joint, a lap joint, or a stepped joint.

There is disclosed in accordance with another aspect of the invention a method of fabricating a slip ring for a rotary electric machine. The method comprises providing an elongate ribbon of electrical conductive material having a generally smooth surface. A pattern is formed on one of the ribbon surfaces. A length of the pattern ribbon is severed and shaped into a cylinder with the patterned surface on an inner wall of the cylinder. A core of thermosetting material is molded at least partially in the cylinder. The core has a through opening receivable on a rotor of a rotary electric machine and a patterned outer surface mating with the cylinder patterned inner surface to secure the cylinder to the core.

Further features and advantages of the invention will be readily apparent from the specification and from the drawings.

### BRIEF DESCRIPTION OF THE DRAWINGS

FIG. 1 is an exploded, perspective view of a slip ring in accordance with the invention and an alternator rotor;

FIG. 2 is a side view of the slip ring of FIG. 1;

FIG. 3 is a sectional view taken along the line 3-3 of FIG. 1;

FIG. 4 is a schematic side elevation view of a multiple pass rolling apparatus for rolling one face of a ribbon of electrically conductive material to form a pattern of ribs, grooves, and tracks;

FIG. 5 is a fragmented side perspective view of a severed length of rolled ribbon prior to being formed into a cylindrical form;

FIG. 6 is a perspective view of a severed ribbon formed into a cylindrical form;

FIG. 7 is a sectional view taken along the line 7-7 of FIG. 5;

FIG. 8 is a partial perspective view of the rolled ribbon of FIG. 7;

FIG. 9 is a sectional view taken along the line 9-9 of FIG. 2; and

FIGS. 10-13 are perspective views, similar to FIG. 6, illustrating alternative configurations of a cylindrical ring.

### DETAILED DESCRIPTION OF THE INVENTION

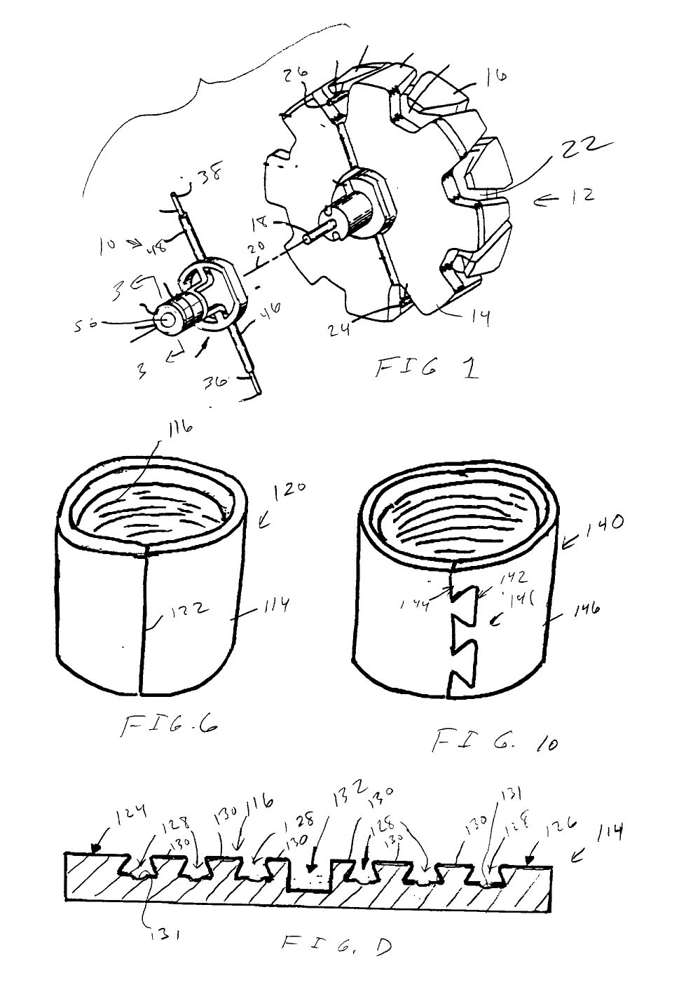

Referring initially to FIG. 1, a slip ring 10 in accordance with the invention is adapted for mounting to a rotary electric machine 12. In the illustrated embodiment of the invention, the rotary electric machine 12 comprises an automotive alternator including first and second pole pieces 14 and 16 mounted on a rotor shaft 18 for rotation about an axis represented by a line 20. The alternator 12 includes a field coil 22 having end wires 24 and 26. As is known, rotation of the shaft causes an alternating electrical current to develop in stator coils (not shown). The slip ring 10 is connected to the brushes (not shown) in a conventional fashion to deliver electrical power to the field coil 22.

While the slip ring 10 is described for use with an alternator 12, the slip ring 10 could be used with other types of rotary electrical machines including generators or motors.

Referring also to FIGS. 2 and 3, the slip ring 10 comprises first and second conductive rings, 30 and 32, respectively, a core 34 and first and second L-shaped terminals 36 and 38. The cylindrical rings 30 and 32 are of an electrically conductive material, such as copper. The cylindrical rings 30 and 32 are of similar size and are coaxially mounted on the core, as described below, axially spaced from one another. As shown in FIG. 8, each ring 30 and 32 has a generally smooth outer surface 40 and a patterned inner surface 42.

The core 34 is of one-piece construction and includes a bobbin 44 received in and supporting the cylindrical rings 30 and 32 and connected to opposite L-shaped support legs 46 and 48. The terminals 36 and 38 pass through the respective support legs 46 and 48, as is particularly illustrated in FIG. 3. The first terminal 36 is electrically connected to the first cylindrical ring 30 as indicated at 52. The second terminal 38 is electrically connected to the second conductive ring 32 as at 54. The electrical connections at 52 and 54 may be made as by welding. The bobbin 44 includes a through opening 56 receivable on the alternator rotor 18 as generally illustrated in FIG. 1. When the slip ring 10 is mounted to the alternator 12 the slip ring terminals 36 and 38 are electrically connected to the respective coil winding ends 24 and 26 in a conventional manner. As such, the conductive rings define rotary termination points for the coil 22.

In accordance with the invention, the cylindrical rings 30 and 32 include a longitudinally extending discontinuity 58, see FIG. 2. Additionally, the core bobbin 44 has a patterned outer surface 60, see FIG. 9, mating with the cylindrical ring patterned inner surfaces 42 to secure the cylindrical rings 30 and 32 to the core bobbin 44. Particularly, the cylindrical ring patterned inner surface 42 comprises a plurality of circumferentially extending dovetail grooves 62 and the bobbin patterned outer surface 60 comprises a plurality of circumferentially extending dovetail ribs 64 received in the grooves 62 to define dovetail joints. The use of the interlocking patterned surfaces 42 and 60 provides a slip ring 10 which accommodates differential thermal expansion and provides locking of the rings 30 and 32 to the core material.

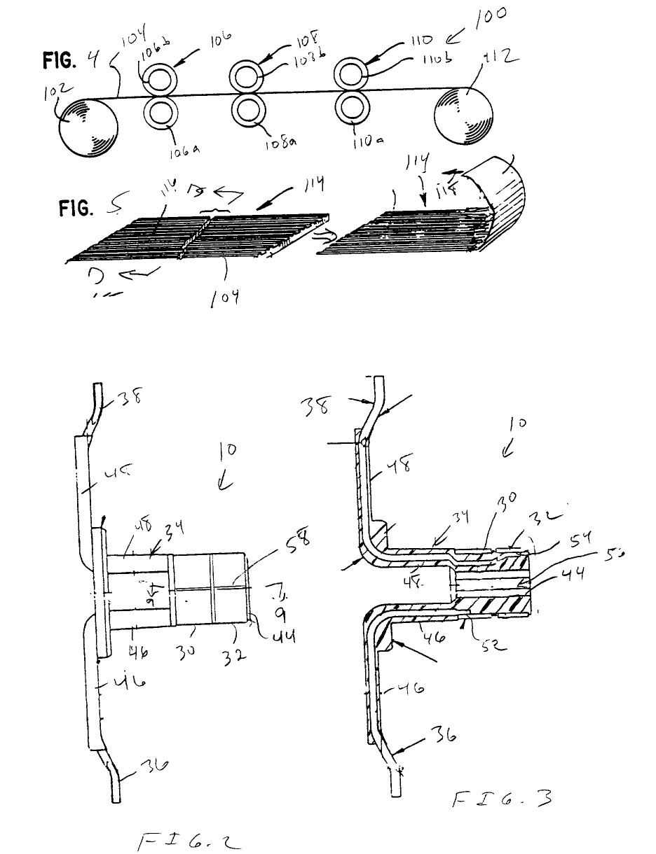

The method of manufacturing the slip ring 10 is now described with reference to FIGS. 4-7. Referring initially to FIG. 4, a multiple-pass rolling apparatus 100 includes a supply reel 102 that feeds an elongated web or ribbon 104 of electrically conductive material, such as copper, through plural sets of rollers, generally designated 106, 108 and 110. Conventionally, bottom rollers 106a, 108a and 110a comprise backup rollers having smooth cylindrical outer surfaces. Upper rollers 106b, 108b and 110b have circumferential ribbed patterns for forming a rib, groove and track pattern 116 on a top surface of the ribbon 104. After forming the pattern 116, the ribbon 104 is wound onto a take up reel 112 for further processing.

FIG. 5 shows the subsequent processing step of severing a predetermined length, generally designated 114, from the ribbon 104. The pattern 116 can be seen on the top surface of the ribbon 104. The next step is to turn the length 114, as indicated by an arrow 118, to shape the severed length 114 into a cylinder 120, see FIG. 6, so that the rib and groove pattern 116 is on the inside thereof. Ends of the severed length 114 abut to form a straight butt joint 122 which defines a discontinuity in the cylinder 120.

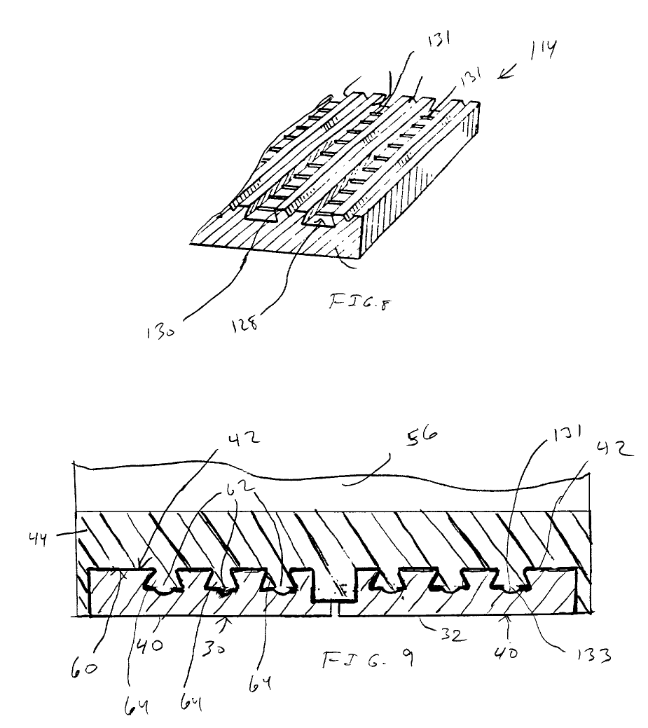

FIG. 7 illustrates a sectional view and FIG. 8 a perspective view of the pattern 116 formed with the rolling apparatus 100 of FIG. 4. Opposite longitudinal edges 124 and 126 of the length 114 comprises flat lands for welding of terminals 36 and 38, as discussed above. Plural longitudinally extending dovetail grooves 128 are separated by ribs 130. Longitudinally spaced indentations 131 in each groove 128 define a track. A rolled center land 132 extends longitudinally midway between the edges 124 and 126 to facilitate parting of the cylinder 120 into two halves to form the two cylindrical rings 32 and 34, discussed above. Thus, in the illustrated embodiment, there are three longitudinally extending grooves disposed between the center land 132 and each of the longitudinal edges 124 and 126. However, any number of grooves could be used as will be apparent to those skilled in the art.

The rolling apparatus 100 may utilize a rolling technique such as described in Wojcik, U.S. Pat. No. 4,920,633 owned by the assignee of the present application, the specification of which is hereby incorporated by reference herein. As is apparent, the rolling apparatus would be modified to produce the indentations 131 and the center land 132. The rib, groove and track pattern 116 may also be formed by other apparatus, as will be apparent to those skilled in the art. As is apparent, the pattern 116, after further processing, defines the inner patterned surface 42 discussed above.

The terminals 36 and 38 are welded to the respective lands 124 and 126. The core 34 is formed by in situ molding using a thermosetting plastic such as, for example, phenolic, epoxy, polyesters, alkyds, etc. The ring 120 would be supported in a suitable mold which is injected with thermosetting plastic in the usual manner. The cylinder 120 acts as part of the mold so that the thermosetting plastic fills the dovetail grooves 128, and the indentations 131. Upon setting, the plastic in the grooves 128 become the dovetail ribs 64 shown in FIG. 9 to provide the dovetail joint. Plastic also fills the indentations 131 to form nubs 133, see FIG. 9. Upon hardening, the longitudinally spaced nubs 133 extend into the longitudinally spaced indentations 131 to prevent rotational movement between the ring and the core to minimize stresses transferred to terminal weld joints. Thereafter, the cylindrical ring 120 is split into the two conductor rings 30 and 32 at the same time the outer contact surface is lathed in situ, as is done with prior slip ring manufacturing. However, as will be apparent, in some designs there may be two rings to start with or there may only be a single ring used. The resulting structure is shown in FIGS. 1-3 and in cross section in FIG. 9.

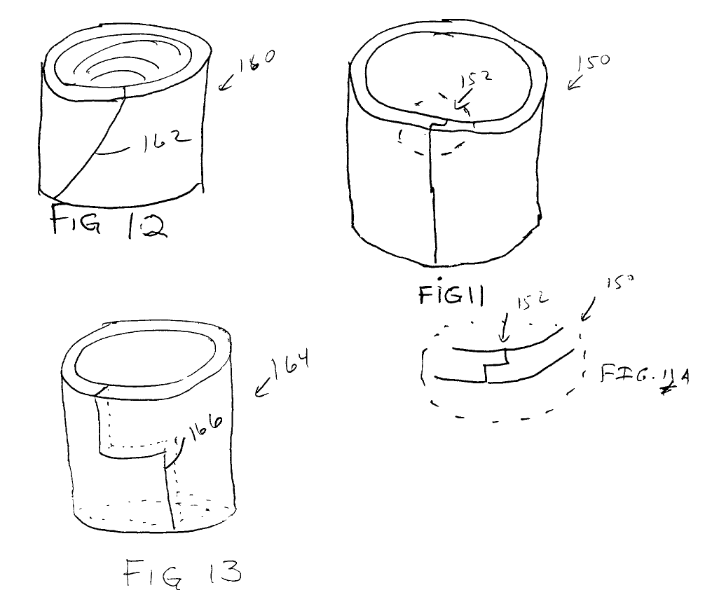

The cylinder 120 described above uses the straight butt joint 122 shown in FIG. 6. In accordance with an alternative embodiment of the invention, a cylinder 140, otherwise similar to the cylinder 120, uses a lockstitch joint 141 as shown in FIG. 10. The lockstitch joint 141 is formed by providing a dovetail mortis 142 at one end of a severed length 146 and a dovetail tenon 144 at another end of the severed length 146. The dovetail mortis 142 and dovetail tenon 144 are formed as part of severing the ribbon into predetermined lengths, as discussed above relative to FIG. 5, or in a subsequent operation before forming the cylinder 140.

In accordance with a further alternative embodiment of the invention, a cylinder 150, see FIG. 11, otherwise similar to the cylinder 120, uses a lap joint shown in detail in FIG. 11A. FIG. 12 shows a further alternative embodiment of the invention for a cylinder 160 including a diagonal joint 162.

FIG. 13 shows still another alternative embodiment of the invention for a cylinder 164 including a stepped joint or seam 166.

The described slip ring 10 provides numerous advantages. These advantages include a rounder slip ring which is more stable. The slip ring can operate at higher wattage due to better heat sink capabilities. The slip ring 10 is more economical to produce. Finally, compared to deep drawing the cylinder can be shorter to the extent of the deep draw radius.

In the illustrated embodiment of the invention, the grooves and ribs extend circumferentially and define dovetail joints. As is apparent, the ribs and grooves could extend laterally or diagonally. Likewise, the ribs and grooves need not have dovetails. Other configurations that provide the desired mechanical locking can be used as will be apparent to those skilled in the art.

I claim:

1. A slip ring for a rotary electric machine comprising:
a cylindrical ring of electrically conductive material, the ring having a generally smooth outer surface and a patterned inner surface; and
a core of thermosetting material at least partially received in the cylindrical ring, the core having a through opening receivable on a rotor of a rotary electrical machine, in use, and a patterned outer surface mating with the cylindrical ring patterned inner surface to secure the cylindrical ring to the core.

2. The slip ring of claim 1 wherein the patterned inner surface comprises dovetail grooves and the patterned outer surface comprises dovetail ribs to define dovetail joints.

3. The slip ring of claim 2 wherein the grooves and ribs comprise circumferentially extending grooves and ribs.

4. The slip ring of claim 1 wherein the patterned inner surface comprises a plurality of circumferentially extending dovetail grooves and the patterned outer surface comprises a plurality of circumferentially extending dovetail ribs to define dovetail joints.

5. The slip ring of claim 1 wherein the cylindrical ring comprises a longitudinally extending discontinuity to accommodate thermal expansion.

6. The slip ring of claim 5 wherein the discontinuity comprises a straight butt joint.

7. The slip ring of claim 5 wherein the discontinuity comprises a lock stitch joint.

8. The slip ring of claim 5 wherein the discontinuity comprises a diagonal joint.

9. The slip ring of claim 5 wherein the discontinuity comprises a lap joint.

10. The slip ring of claim 5 wherein the discontinuity comprises a stepped seam.

11. The slip ring of claim 2 wherein the patterned inner surface further comprises indentations in the grooves and the patterned outer surface comprises nubs extending into the grooves.

12. A slip ring for a rotary electric machine comprising:
first and second cylindrical rings of electrically conductive material, each ring having a generally smooth outer surface and a patterned inner surface;
a core of thermosetting material at least partially received in the cylindrical rings to support the rings coaxial to one another, the core having a through opening receivable on a rotor of a rotary electrical machine, in use, and a patterned outer surface mating with the cylindrical ring patterned inner surfaces to secure the cylindrical rings to the core; and
first and second terminals electrically connected to the respective first and second rings and extending through the core for connecting to the rotary electrical machine.

13. The slip ring of claim 12 wherein the patterned inner surface comprises dovetail grooves and the patterned outer surface comprises dovetail ribs to define dovetail joints.

14. The slip ring of claim 13 wherein the grooves and ribs are comprises circumferentially extending grooves and ribs.

15. The slip ring of claim 12 wherein the patterned inner surface comprises a plurality of circumferentially extending dovetail grooves and the patterned outer surface comprises a plurality of circumferentially extending dovetail ribs to define dovetail joints.

16. The slip ring of claim 12 wherein each cylindrical ring comprises a longitudinally extending discontinuity.

17. The slip ring of claim 16 wherein each discontinuity comprises a straight butt joint.

18. The slip ring of claim 16 wherein the discontinuity comprises a lock stitch joint.

19. The slip ring of claim 16 wherein the discontinuity comprises a diagonal joint.

20. The slip ring of claim 16 wherein the discontinuity comprises a lap joint.

21. The slip ring of claim 13 wherein the patterned inner surface further comprises indentations in the grooves and the patterned outer surface comprises nubs extending into the grooves.

22. A method of fabricating a slip ring for a rotary electric machine comprising:
providing an elongate ribbon of electrically conductive material having generally smooth surfaces;
forming a pattern on one of the ribbon surfaces;
severing a length of the patterned ribbon and shaping the severed length into a cylinder with the patterned surface on an inner wall of the cylinder; and
molding a core of thermosetting material at least partially in the cylinder, the core having a through opening receivable on a rotor of a rotary electrical machine, in use, and a patterned outer surface mating with the cylinder patterned inner surface to secure the cylinder to the core.

23. The method of claim 22 wherein said ribbon comprises a copper ribbon.

24. The method of claim 22 wherein the cylinder patterned inner surface comprises dovetail grooves and the core patterned outer surface comprises dovetail ribs to define dovetail joints.

25. The method of claim 22 further comprising cutting a circumferential slot in the cylinder to provide two slip rings.

26. The method of claim 25 further comprising providing first and second terminals secured to the cylinder prior to molding the core, whereby the terminals are received in the core and are each secured to one of the slip rings.

27. The method of claim 22 wherein severing the ribbon comprises providing dovetail mortise at one end of the severed length and dovetail tenons at another end of the severed length to provide a lock stitch joint in the cylinder.
